(19) United States
(12) Patent Application Publication
(10) Pub. No.: US 2024/0305982 A1
(43) Pub. Date: Sep. 12, 2024

(54) SECURE AUTHENTICATION AND IDENTIFICATION IN TRUSTED NON-3GPP ACCESS NETWORKS

(71) Applicant: Intel Corporation, Santa Clara, CA (US)

(72) Inventor: Abhijeet Ashok Kolekar, Hillsboro, OR (US)

(21) Appl. No.: 18/652,881

(22) Filed: May 2, 2024

Related U.S. Application Data
(60) Provisional application No. 63/501,291, filed on May 10, 2023.

(51) Int. Cl. H04W 12/06; H04W 12/106; H04W 12/72; H04W 60/04

(52) U.S. Cl. CPC H04W 12/06; H04W 12/106; H04W 12/72; H04W 60/04

(57) ABSTRACT

An apparatus and system are described for secure authentication and identification in trusted non-3GPP access networks. A temporary identifier is generated by a trusted non-3GPP gateway function (TNGF) and sent to a user equipment (UE) over an encrypted channel. The temporary identifier is unique and not associated with personally identifiable information of a user of the UE. The UE uses the temporary identifier to establish a secure connection with the TNGF.

### PRIORITY CLAIM

This application claims the benefit of priority to U.S. Provisional Patent Application Ser. No. 63/501,291, filed May 10, 2023, which is incorporated herein by reference in its entirety.

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new system, including complexities related to the security related to trusted non-3GPP access networks.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some aspects.

FIG. 3 illustrates registration/authentication and protocol data unit (PDU) Session establishment for trusted non-3GPP access in accordance with some aspects.

FIG. 4 illustrates a method of establishing a connection with a non-3GPP network in accordance with some aspects.

FIG. 5 illustrates a method of obtaining a temporary identifier in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

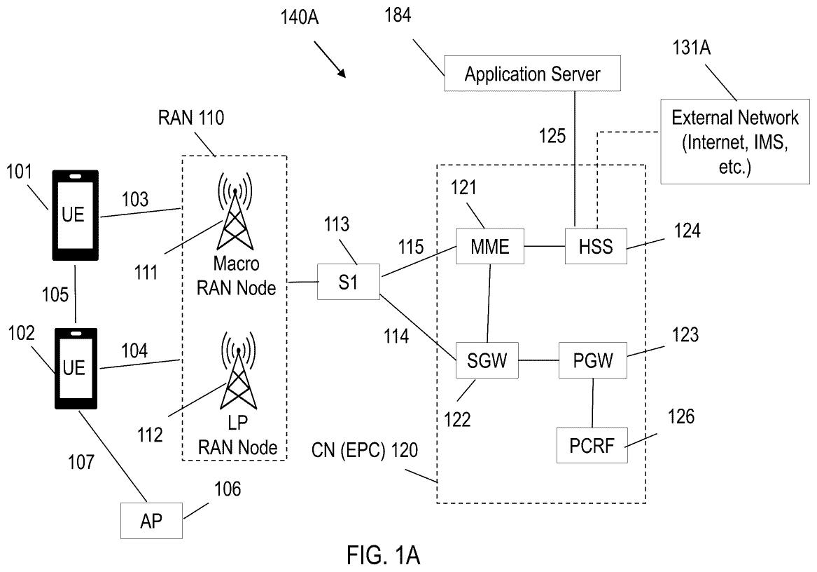

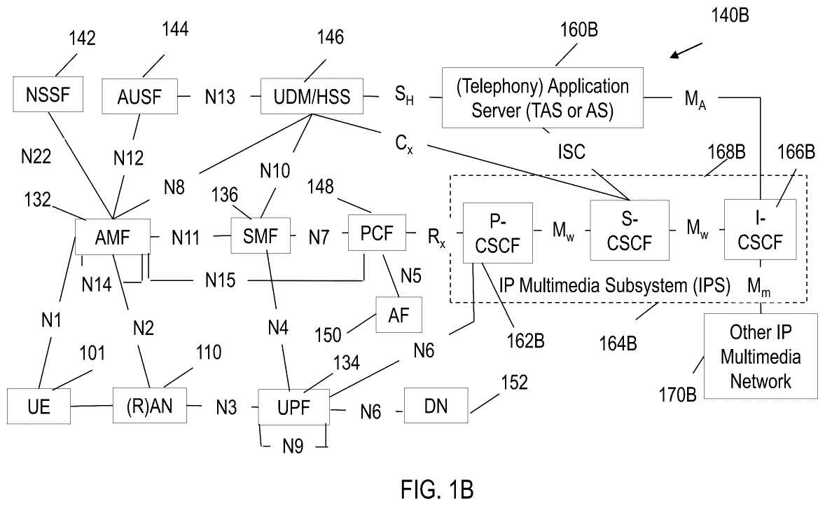

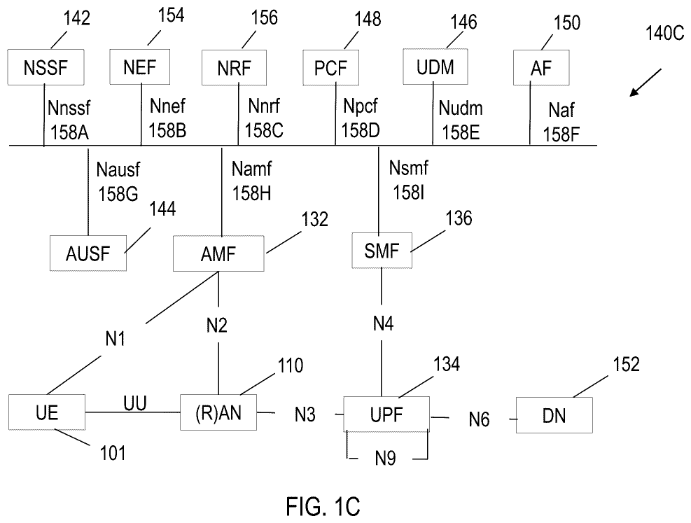

FIG. 1A illustrates an architecture of a network in accordance with some aspects. The network 140A includes 3GPP Long Term Evolution (LTE), 4th generation (4G) and 5th generation (5G) (or next generation (NG)) network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a UMTS protocol, a 3GPP LTE protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), 5th Generation NodeBs (gNBs), RAN nodes, and the like, and can comprise ground stations (e.g., terrestrial access points) or satellite access nodes (SANs) providing coverage within a geographic area (e.g., a cell) and/or non-terrestrial networks. In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node. Accordingly, the term gNB is used as a shorthand to refer to any type of RAN node capable of providing the functionality described herein.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

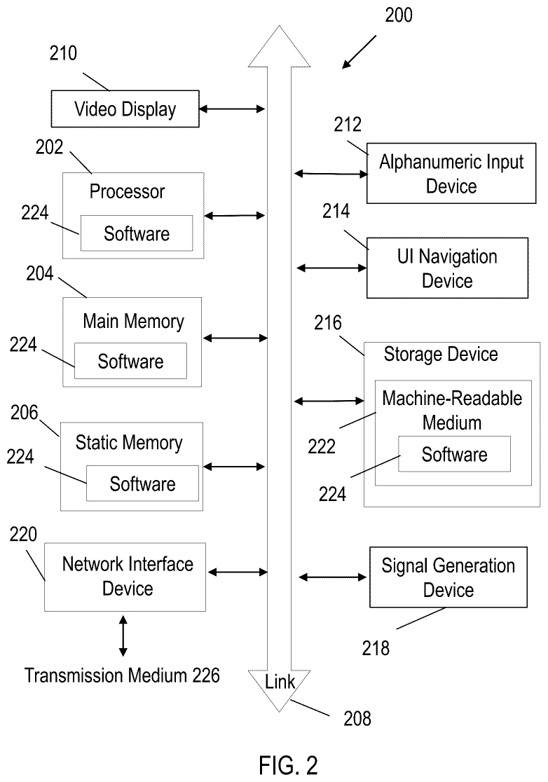

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as IEEE 802.11 family of standards known as Wi-Fi, IEEE 802.16 family of standards known as WiMax, IEEE 802.15.4 family of standards, an LTE family of standards, a UMTS family of standards, peer-to-peer (P2P) networks, a 5G standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology, for example UMTS, Freedom of Multimedia Access (FOMA), 3GPP LTE, 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), UMTS (3G), Wideband Code Division Multiple Access (UMTS) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), TD-CDMA, Time Division-Synchronous Code Division Multiple Access, 3rd Generation Partnership Project Release 8 (Pre-4th Generation) (3GPP Rel. 8 (Pre-4G)), and subsequent Releases (such as Rel. 9-19, etc.), 3GPP 5G, 5G, 5G New Radio (5G NR), 3GPP 5G New Radio, 3GPP NR NTN (Non-terrestrial NTN), 3GPP LTE Extra, LTE-Advanced Pro, LTE Licensed-Assisted Access (LAA), MuLTEfire, UMTS Terrestrial Radio Access (UTRA), E-UTRA, LTE Advanced (4G), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), PTT, Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.1 lay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, Dedicated Short Range Communications (DSRC) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.1 1bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHZ and further frequencies and SAS=Spectrum Access System/CBRS=Citizen Broadband Radio System in 3.55-3.7 GHZ and further frequencies). Applicable spectrum bands include International Mobile Telecommunications spectrum as well as other types of spectrum/bands, such as bands with national allocation (including 450-470 MHz, 902-928 MHZ (note: allocated for example in US (FCC Part 15)), 814-894 MHZ (note: 3GPP band n26), 703-803 MHz (note: 3GPP band n28), 698-746 MHz (note: lower 700 MHz spectrum in US, 3GPP band n85), 874-925 MHZ (note: 3GPP band n100), 450-470 MHz (note: 3GPP bands n31, n72), 863-868.6 MHz (note: allocated for example in European Union (ETSI EN 300 220)), 915.9-929.7 MHz (note: allocated for example in Japan), 917-923.5 MHZ (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHZ, 38.6-40 GHz, 42-42.5 GHz, 57-64 GHz, 71-76 GHz, 81-86 GHz and 92 -94 GHz, etc.), the ITS (Intelligent Transport Systems) band of 5.9 GHZ (typically 5.85-5.925 GHz) and 63-64 GHz, bands currently allocated to WiGig such as WiGig Band 1 (57.24-59.40 GHZ), WiGig Band 2 (59.40-61.56 GHz) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHZ spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHZ) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

As above, UEs may connect to a home network through different types of networks, which include both trusted and non-trusted 3GPP and non-3GPP networks. Non-trusted networks may employ various security interactions to permit UE network access. In particular, a secure authentication and identification mechanism in trusted non-3GPP access networks is disclosed herein. The system includes a trusted non-3GPP gateway function (TNGF) and UE in which a temporary identifier is generated by the TNGF and sent to the UE over an encrypted channel. The UE uses the temporary identifier to establish a secure connection with the TNGF. The temporary identifier is unique and not associated with personally identifiable information. The method and system enable secure authentication and identification of the UE in a trusted non-3GPP access network.

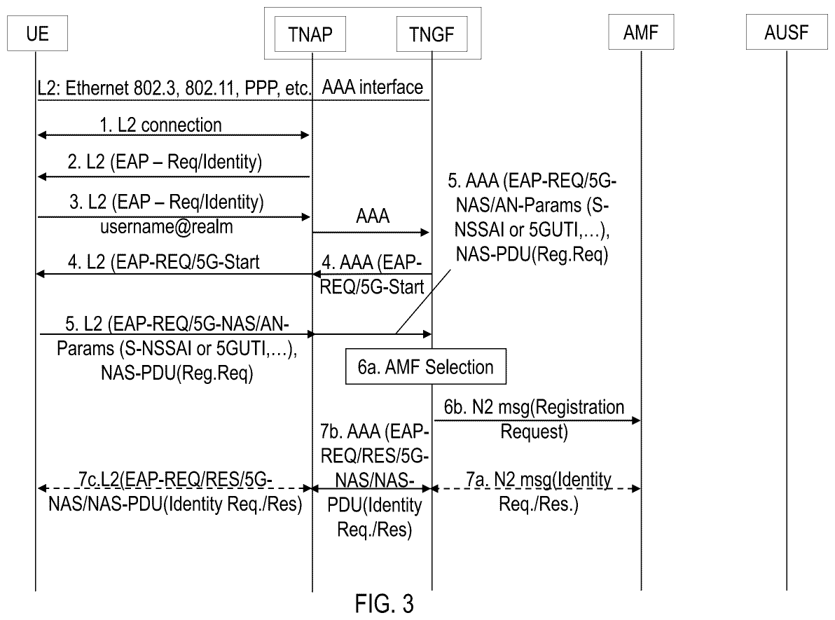

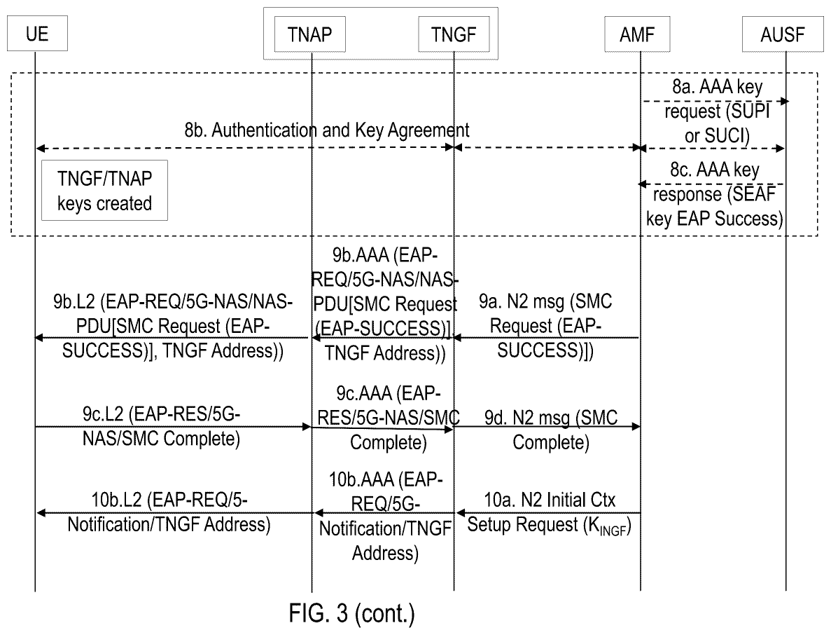

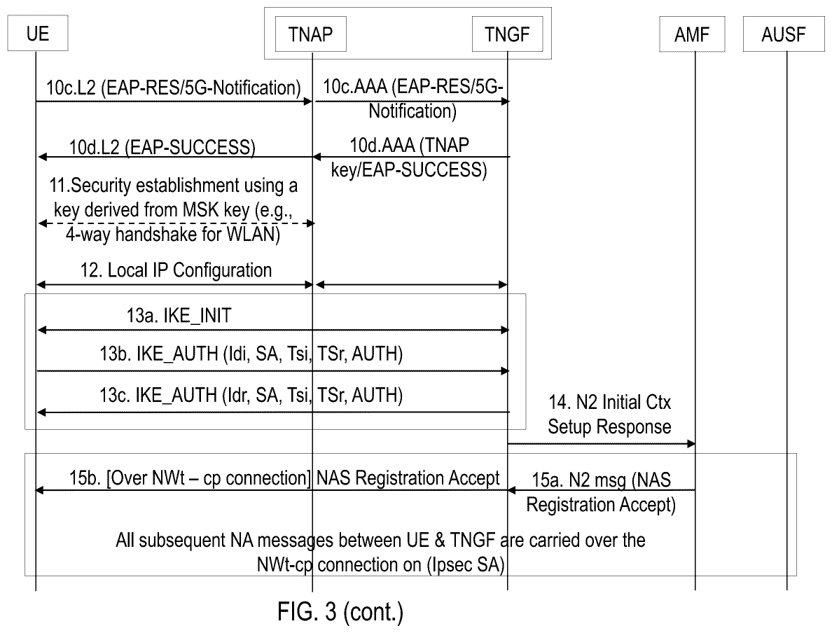

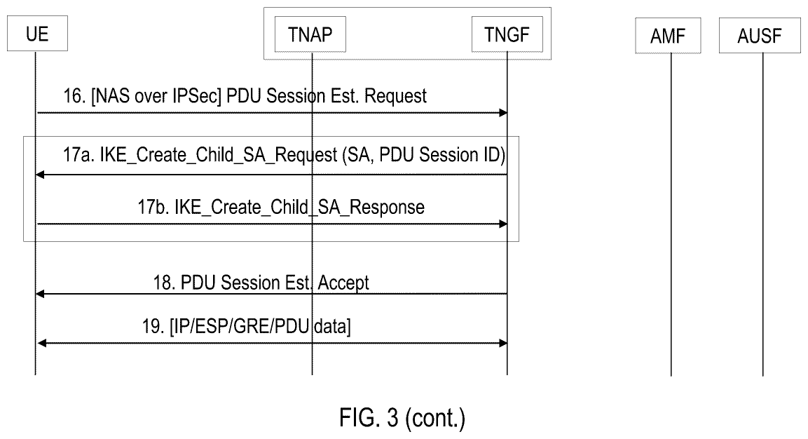

FIG. 3 illustrates registration/authentication and PDU Session establishment for trusted non-3GPP access in accordance with some aspects. FIG. 3 specifies how a UE is authenticated to 5G network via a trusted non-3GPP access network. FIG. 3 is based on the specified procedure in TS 23.502 clause 4.12a.2.2 “Registration procedure for trusted non-3GPP access”; the authentication procedure is similar to the authentication procedure for untrusted non-3GPP access defined in clause 7.2.1 of 3GPP TS 33.501 (provided later for completeness). The operations shown in FIG. 3 include:

At operation 0, the UE selects a PLMN and a trusted network access node (TNAN) for connecting to this PLMN by using the Trusted Non-3GPP Access Network selection procedure specified in TS 23.501 clause 6.3.12. During this procedure, the UE discovers the PLMNs with which the TNAN supports trusted connectivity (e.g., “5G connectivity”).

At operation 1, a layer-2 connection is established between the UE and a Trusted Non-3GPP Access Point (TNAP). For an IEEE 802.11 connection (WiFi), this operation corresponds to an 802.11association. For a Point-to-Point Protocol (PPP), this operation corresponds to a PPP link control protocol (LCP) negotiation. In other types of non-3GPP access (e.g., Ethernet), this operation may be avoided.

At operations 2-3, an Extensible Authentication Protocol (EAP) authentication procedure is initiated. EAP messages are encapsulated into layer-2 packets, e.g., into IEEE 802.3/802.1x packets, into IEEE 802.11/802.1x packets, into PPP packets, etc. The UE provides a Network Access Identifier (NAI) that triggers the TNAP to send an Authentication, Authorization, Accounting (AAA) request to a TNGF. Between the TNAP and TNGF the EAP packets are encapsulated into AAA messages.

At operations 4-10, an EAP-5G procedure is executed similar to that specified in clause 7.2.1. However, EAP-5G packets are not encapsulated into Internet Key Exchange v2 (IKEv2) packets. The UE includes a UE ID in the access network (AN) parameters, e.g., a 5G Globally Unique Temporary Identifier (5G-GUTI) if available from a prior registration to the same PLMN. A TNGF Key (K_{TNGF}) as specified in clause Annex A.9 (equivalent to K_{N3IWF}) is created in the UE and in the AMF after the successful authentication. The K_{TNGF} is transferred from the AMF to the TNGF in operation 10a (within the N2 Initial Context Setup Request).

In operation 9b, when an anonymous Subscription Concealed Identifier (SUCI) has been used in operation 5, a shrouded identifier, such as a unique temporary identifier allocated by the TNGF and/or the anonymous SUCI, is transferred to the UE alongside the TNGF address.

The TNAP is a trusted entity. The TNGF generates the KTNAP as specified in Annex A.22 and transfers the KTNAP from the TNGF to the TNAP in operation 10b (within an AAA message).

After receiving the TNGF key from the AMF in operation 10a, the TNGF sends to the UE an EAP-Request/5G-Notification packet containing the “TNGF Contact Info”, which includes the IP address of the TNGF. After receiving an EAP-Response/5G-Notification packet from the UE, the TNGF sends message 10b containing the EAP-Success packet.

At operation 11, the common TNAP key is used by the UE and TNAP to derive security keys according to the applied non-3GPP technology and to establish a security association to protect all subsequent traffic. For IEEE 802.11, the KTNAP is the Pairwise Master Key (PMK) and a 4-way handshake is executed (see IEEE 802.11), which establishes a security context between the WLAN AP and the UE that is used to protect unicast and multicast traffic over the air. All messages between the UE and TNAP are encrypted and integrity protected from this step onwards. However, this procedure assumes the encryption protection over Layer-2 between the UE and TNAP is to be enabled.

At operation 12, the UE receives an IP configuration from the TNAN, e.g., with Dynamic Host Configuration Protocol (DHCP).

At operation 13, the UE initiates an IKE_INIT exchange with the TNGF. The UE received the IP address of TNGF during the EAP-5G signaling in operation 9b, subsequently, the UE initiates an IKE_AUTH exchange and includes the same UE ID (i.e., SUCI or 5G-GUTI) as in the UE ID provided in operation 5. In operation 13b, the shrouded identifier such as the unique temporary identifier provided in operation 9b is used as IDi in case an anonymous identifier was used in operation 5. The common key K_{TIPSe} is used for mutual authentication. The key K_{TIPSe} is derived as specified in Annex A.22.NULL encryption is negotiated as specified in RFC 2410. After operation 13c, an IP security (IPsec) security association (SA) is established between the UE and TNGF (i.e., a NWt connection) and is used to transfer all subsequent non-access stratum (NAS) messages. The IPsec SA does not apply encryption but only applies integrity protection.

At operation 14, after the NWtp connection is successfully established, the TNGF responds to AMF with an N2 Initial Context Setup Response message.

At operation 15, the NAS Registration Accept message is sent by the AMF and is forwarded to the UE via the established NWt connection.

At operations 16-18, the UE initiates a PDU session establishment. This is carried out as specified in TS 23.502 clause 4.12a.5. The TNGF may establish one or more IPSec child SA's per PDU session.

At operation 19, user plane data for the established PDU session is transported between the UE and TNGF inside the established IPSec child SA.

### Temporary Identifier:

Various embodiments may be used to develop an effective identifier to index K_{TNGF} in the 7A.2.1 Authentication for trusted non-3GPP access.

In some embodiments, a unique identifier may be generated for each anonymous SUCI. The unique identifier may then map the user to the correct K_{TNGF}. This may be achieved by using a hash function to generate a unique identifier based other user information, such as the user's device ID.

In some embodiments, a temporary identifier may be used for each session. The temporary identifier may be generated by the UE and sent to the TNGF during the authentication process (operation 8). This identifier may be used to map the user to the correct K_{TNGF} and discarded after the session.

When using temporary identifiers to prevent exposure of personal information, the temporary identifiers may be generated to minimize the likelihood of collisions. A number of variations, which may be used alone or in combination, may be used to avoid collision issues. Use of a longer and random string, such as a Universally Unique Identifier (UUID), may greatly reduce the chances of collision. Since the identifier is random, the chances of generating the same identifier for two different users are extremely low. Adding a timestamp or salt to the identifier may also help to reduce the chances of collision. For example, an identifier that includes a timestamp or a random salt may be unique for each user. A hash function may be used to generate a unique identifier for each user. This approach works by taking the user's personal information and generating a hash, which is then used as the identifier. Since the hash is unique for each user, collision issues may be avoided. Using a database or key-value store to store temporary identifiers may also help to prevent collisions. When a new identifier is generated, the new identifier may be checked against the database to ensure that the new identifier is unique before use. In this case, the TNGF may send the identifier back to the UE instead of the UE generating the identifier.

Integrity of the Temporary Identifier:

The temporary identifier is sent over a layer-2 connection in operation 9. This connection, however, may not be secured until operation 11 when the security keys are derived from the K_{TNGF}. Without integrity protection, there is a risk that the identifier may be manipulated, leading to a denial of service in operation 13. To mitigate this risk, a message authentication code (MAC) or a digital signature may be used to provide integrity protection for the temporary identifier. This may be done by having the TNGF compute a MAC or digital signature over the identifier using a secret key that is shared with the UE during the security setup in operation 11. The UE may then verify the MAC or digital signature before using the identifier in operation 13. In some embodiments, the identifier may be unique and generated randomly. In some embodiments, verification includes checking uniqueness of the temporary identifier against a database of previously generated temporary identifiers.

Clause 7.2.1 specifies how a UE is authenticated to 5G network via an untrusted non-3GPP access network. It uses a vendor-specific EAP method called “EAP-5G”, utilizing the “Expanded” EAP type and the existing 3GPP Vendor-Id, registered with Internet Assigned Numbers Authority (IANA) under the SMI Private Enterprise Code registry. The “EAP-5G” method is used between the UE and the N3IWF and is utilized for encapsulating NAS messages. If the UE is to be authenticated by the 3GPP home network, any of the authentication methods as described in clause 6.1.3 can be used. The method is executed between the UE and AUSF as shown below.

At operation 1, the UE connects to an untrusted non-3GPP access network. When the UE decides to attach to 5GC network, the UE selects an N3IWF in a 5G PLMN, as described in TS 23.501 clause 6.3.6.

At operation 2, the UE proceeds with the establishment of an IPsec SA with the selected N3IWF by initiating an IKE initial exchange according to RFC 7296. After operation 2, all subsequent IKE messages are encrypted and integrity protected by using the IKE SA established in this operation.

At operation 3, the UE initiates an IKE_AUTH exchange by sending an IKE_AUTH request message. The AUTH payload is not included in the IKE_AUTH request message, which indicates that the IKE_AUTH exchange shall use EAP signaling (in this case EAP-5G signaling). As per the RFC 7296, in the IDi the UE sets the ID type as ID_KEY-ID in this message and sets its value equal to any random number. The UE does not use its GUTI/SUCI/SUPI as the ID in this operation. If the UE is provisioned with the N3IWF root certificate, the UE includes the CERTREQ payload within the IKE_AUTH request message to request N3IWF's certificate.

At operation 4, the N3IWF responds with an IKE_AUTH response message which includes the N3IWF identity, the AUTH payload to protect the previous message sent to the UE (in the IKE_SA_INIT exchange) and an EAP-Request/5G-Start packet. The EAP-Request/5G-Start packet informs the UE to initiate an EAP-5G session, i.e., to start sending NAS messages encapsulated within EAP-5G packets. If the UE has sent a CERTREQ payload in operation 3, the N3IWF also includes the CERT payload including N3IWF certificate.

At operation 5, the UE validates the N3IWF certificate and confirms that the N3IWF identity matches the N3IWF selected by the UE. An absence of the certificate from the N3IWF if the UE had requested the certificate or unsuccessful identity confirmation results in a connection failure. The UE sends an IKE_AUTH request, which includes an EAP-Response/5G-NAS packet that contains a Registration Request message containing UE security capabilities and the SUCI. If UE is already with the 5GC over 3GPP access and there is an available security context, the UE integrity protects the Registration Request message and sends the 5G-GUTI instead of SUCI. The N3IWF refrains from sending an EAP-Identity request. The UE may ignore an EAP Identity request or respond with the SUCI sent in the Registration Request. If the UE has registered to the same AMF through 3GPP access, and if this is the first time that the UE connects to the 5GC through non-3GPP access, the value of corresponding UL NAS COUNT used for integrity protection is 0; else it can use the existing non-3GPP specific UL NAS COUNT for integrity protection. The N3IWF does not send an EAP-Identity request because the UE includes its identity in the IKE_AUTH request in message 5. This is in line with RFC 7296, clause 3.16.

At operation 6, the N3IWF selects an AMF as specified in TS 23.501, clause 6.5.3. The N3IWF forwards the Registration Request received from the UE to the AMF.

At operation 7, if the AMF receives a 5G-GUTI and the Registration is integrity protected, the AMF may use the security context to verify the integrity protection as describe in clause 6.4.6. If the UE has registered to the same AMF through 3GPP access, and if this is the first time that the AMF receives UE's NAS signaling through non-3GPP access, the value of corresponding UL NAS COUNT used for integrity verification is 0; else the AMF can use the existing non-3GPP specific UL NAS COUNT for integrity verification. If integrity is verified successfully, this means that UE is authenticated by AMF. If integrity is verified successfully and no newer security context has been activated over the 3GPP access, then the primary authentication is verified and operation 8 to 11 may be skipped. If integrity is verified successfully and a newer security context has been activated over the 3GPP access, then authentication may be skipped but the AMF activates the newer context with a NAS SMC procedure as described in operation 8 and onwards. Otherwise, the AMF authenticates the UE.

If the AMF decides to authenticate the UE, the AMF uses one of the methods from clause 6.1.3. In this case, the AMF sends a key request to the AUSF. The AUSF may initiate an authentication procedure as specified in clause 6.1.3. Between the AMF and UE, the authentication packets are encapsulated within NAS authentication messages and the NAS authentication messages are carried in N2 signaling between the AMF and N3IWF, and then are encapsulated within EAP-5G/5G-NAS packets between the N3IWF and the UE.

In the final authentication message from the home network, the AUSF sends the anchor key K_{SEAF} derived from K_{AUSF} to the SEAF. The SEAF derives the KAMF from K_{SEAF} and sends KAMF to the AMF, which is used by the AMF to derive NAS security keys. If EAP-AKA′ is used for authentication as described in clause 6.1.3.1, then the AUSF includes the EAP-Success. The UE also derives the anchor key K_{SEAF} and from that key derives the KAMF followed by NAS security keys. The NAS COUNTs associated with NAS connection identifier “0x02” are set at the UE and AMF.

At operation 8, the AMF sends a Security Mode Command (SMC) to the UE to activate NAS security associated with NAS connection identifier “0x02”. This message is first sent to N3IWF (within an N2 message). If EAP-AKA′ is used for authentication, the AMF encapsulates the EAP-Success received from the AUSF within the SMC message.

At operation 9, the N3IWF forwards the NAS SMC to UE within an EAP-Request/5G-NAS packet.

At operation 10, the UE completes the authentication (if initiated in step 7) and creates a NAS security context or activates another one based on the received ngKSI in the NAS SMC. The UE responds to the NAS SMC received from the AMF based on the selected algorithms and parameters as described in clause 6.7.2. The UE encapsulates the NAS SMC Complete in the EAP-5G Response.

At operation 11, the N3IWF forwards the NAS packet containing NAS SMC Complete to the AMF over the N2 interface.

At operation 12, the AMF upon reception of the NAS SMC Complete from the UE or upon success of integrity protection verification, initiates the NGAP procedure to set up the AN context. The AMF computes the N3IWF key, K_{N3IWF}, using the uplink NAS COUNT associated with NAS connection identifier “0x02” as defined in Annex A.9 for the establishment of the IPsec SA between the UE and the N3IWF and includes K_{N3IWF} in the NGAP Initial Context Setup Request sent to the N3IWF.

At operation 13, the N3IWF sends an EAP-Success/EAP-5G to the UE upon reception of the NGAP Initial Context Setup Request containing the N3IWF key, KN3IWF. This completes the EAP-5G session and no further EAP-5G packets are exchanged. If the N3IWF does not receive the KN3IWF from AMF, the N3IWF shll responds with an EAP-Failure.

At operation 14, the IPsec SA is established between the UE and N3IWF by using the N3IWF key KN3IWF that was created in the UE using the uplink NAS COUNT associated with NAS connection identifier “0x02” as defined in Annex A.9 and was received by N3IWF from the AMF in operation 12.

At operation 15, upon successful establishment of the IPsec SA between the UE and the N3IWF, the N3IWF sends the NGAP Initial Context Setup Response message to the AMF.

At operation 15a, the AMF may determine whether the N3IWF is appropriate for the slice selected as defined in clause 4.12.2.2 of TS 23.502. If compatible with the selected N3IWF, then the process proceeds with operations 16 and 17. Otherwise, the AMF proceeds with operations 18 to 20, and operations 16 and 17 are skipped.

### Case a):

At operation 16, when NGAP Initial Context Setup Response for the UE is received by the AMF, the AMF sends the NAS Registration Accept message for the UE over the N2 towards the N3IWF.

At operation 17, upon receiving the NAS Registration Accept message from the AMF, the N3IWF forwards the NAS Registration Accept to the UE over the established IPsec SA. All further NAS messages between the UE and the N3IWF shall be sent over the established IPsec SA.

### Case b):

At operation 18, the AMF may trigger the UE policy update procedure and update the UE policy as defined in operations 15 and 16 in clause 4.12.2.2 of TS 23.502.

At operation 19, the AMF sends a Registration Reject message via N3IWF to the UE as defined in operation 17 in clause 4.12.2.2 of TS 23.502. The Registration Reject message is ciphered and integrity protected.

At operation 20, the UE deciphers and verifies the integrity of the Registration Reject message. If verification is successful, then the UE proceeds with operation 18 in clause 4.12.2.2 of TS 23.502 and sends a Registration request message to the AMF via a new selected N3IWF.

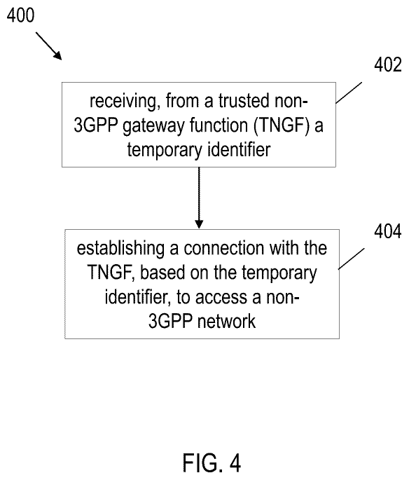

FIG. 4 illustrates a method of establishing a connection with a non-3GPP network in accordance with some aspects. In some embodiments, the electronic device(s), network(s), system(s), chip(s) or component(s), or portions or implementations thereof of the figures herein may be configured to perform one or more processes, techniques, or methods as described herein, or portions thereof. One such process is depicted in FIG. 4. The method 400 may be performed by a UE or a portion thereof. At operation 402, the method 400 may include receiving a temporary identifier from a TNGF. At operation 404, the method 400 may further include establishing a connection with the TNGF to access a non-3GPP network based on the temporary identifier.

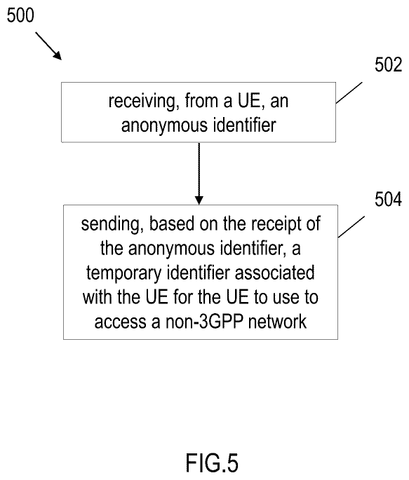

FIG. 5 illustrates a method of obtaining a temporary identifier in accordance with some aspects. The method 500 may be performed by a TNGF or a portion thereof. At operation 502, the method 500 may include receiving an anonymous identifier from a UE. At operation 504, the method 500 may further include sending, based on the receipt of the anonymous identifier, a temporary identifier associated with the UE for the UE to use to access a non-3GPP network.

### Examples

Example 1 is an apparatus for a user equipment (UE), the apparatus comprising: processing circuitry configured to: decode, from a Trusted Non-3GPP Access Point (TNAP), an Extensible Authentication Protocol (EAP)-Request/5th generation (5G)-Start packet to initiate an EAP-5G session; in response to the EAP-Request/5G-Start packet, encode, for transmission to the TNAP, an EAP-Response/5G-non-access stratum (NAS) packet that contains a Registration Request message containing UE security capabilities and an anonymous Subscription Concealed Identifier (SUCI); and after transmission of the EAP-Response/5G-NAS packet, decode, from the TNAP, an EAP-Request/5G-NAS packet that contains: a NAS Security Mode Command (SMC) message including an EAP-Success message indicating authentication of the UE, a trusted non-3GPP gateway function (TNGF) address, and a shrouded identifier; and a memory configured to store the anonymous SUCI.

In Example 2, the subject matter of Example 1 includes, wherein the shrouded identifier is at least one of the anonymous SUCI or a unique temporary identifier allocated by a TNGF.

In Example 3, the subject matter of Example 2 includes, wherein the processing circuitry is configured to initiate an Internet Key Exchange authentication (IKE_AUTH) exchange with the TNGF that uses the at least one of the anonymous SUCI or unique temporary identifier.

In Example 4, the subject matter of Example 3 includes, wherein initiate the IKE_AUTH exchange with the TNGF, the processing circuitry is configured to: encode, for transmission to the TNGF, an IKE_AUTH request that includes the at least one of the anonymous SUCI or unique temporary identifier; and decode, from the TNGF in response to the IKE_AUTH request, an IKE_AUTH response that includes the at least one of the anonymous SUCI or unique temporary identifier.

In Example 5, the subject matter of Examples 2-4 includes, wherein the at least one of the anonymous SUCI or unique temporary identifier is a random number.

In Example 6, the subject matter of Examples 2-5 includes, connection and at least one of a message authentication code (MAC) or a digital signature is used to provide integrity protection for the at least one of the anonymous SUCI or unique temporary identifier.

In Example 7, the subject matter of Example 6 includes, wherein the processing circuitry is configured to: share a secret key with the TNGF during security setup after reception of the EAP-Request/5G-NAS packet; and verify the at least one of the MAC or digital signature before using the at least one of the anonymous SUCI or unique temporary identifier during initiation of an Internet Key Exchange authentication (IKE_AUTH) exchange with the TNGF that uses the at least one of the anonymous SUCI or unique temporary identifier.

In Example 8, the subject matter of Examples 2-7 includes, wherein the unique temporary identifier is unique for each SUCI and mapped to a TNGF Key (K_{TNGF}) of the TNGF.

In Example 9, the subject matter of Examples 2-8 includes, wherein the processing circuitry is configured to: generate a UE temporary identifier unique for each session; and encode the UE temporary identifier for transmission to the TNGF during authentication for a session prior to reception of the EAP-Request/5G-NAS packet, the UE temporary identifier used to map the UE to a TNGF Key (K_{TNGF}) of the TNGF and discarded after the session.

In Example 10, the subject matter of Example 9 includes, wherein the processing circuitry is configured to generate the UE temporary identifier randomly based on a Universally Unique Identifier (UUID) of the UE.

In Example 11, the subject matter of Examples 9-10 includes, wherein the processing circuitry is configured to generate the UE temporary identifier by adding a timestamp or random salt to another generated temporary identifier.

In Example 12, the subject matter of Examples 9-11 includes, wherein the processing circuitry is configured to generate the UE temporary identifier randomly based on a hash function of personal information of a user of the UE.

In Example 13, the subject matter of Examples 2-12 includes, wherein: the unique temporary identifier is based on a database or key-value store to ensure uniqueness before use, and the processing circuitry is configured to decode, from the TNGF, a UE temporary identifier, and encode the UE temporary identifier for transmission to the TNGF during authentication for a session prior to reception of the EAP-Request/5G-NAS packet, the UE temporary identifier used to map the UE to a TNGF Key (K_{TNGF}) of the TNGF.

Example 14 is an apparatus for a Trusted Non-3GPP Access Point (TNAP), the apparatus comprising: processing circuitry configured to: encode, for transmission to a user equipment (UE), an Extensible Authentication Protocol (EAP)-Request/5th generation (5G)-Start packet to initiate an EAP-5G session; in response to the EAP-Request/5G-Start packet, decode, from the UE, an EAP-Response/5G-NAS packet that contains a Registration Request message containing UE security capabilities and an anonymous Subscription Concealed Identifier (SUCI); and after reception of the EAP-Response/5G-NAS packet, encode, for transmission to the UE, an EAP-Request/5G-NAS packet that contains: a NAS Security Mode Command (SMC) message including an EAP-Success message indicating authentication of the UE, a trusted non-3GPP gateway function (TNGF) address, and a shrouded identifier; and a memory configured to store the unique temporary identifier.

In Example 15, the subject matter of Example 14 includes, wherein the shrouded identifier is at least one of the anonymous SUCI or a unique temporary identifier allocated by a TNGF.

In Example 16, the subject matter of Example 15 includes, wherein the processing circuitry is configured to: decode, from the UE, an Internet Key Exchange authentication (IKE_AUTH) request that includes the at least one of the anonymous SUCI or unique temporary identifier; and encode, for transmission to the UE in response to the IKE_AUTH request, an IKE_AUTH response that includes the at least one of the anonymous SUCI or unique temporary identifier.

In Example 17, the subject matter of Examples 15-16 includes, wherein the at least one of the anonymous SUCI or unique temporary identifier is a random number.

In Example 18, the subject matter of Examples 15-17 includes, wherein: the unique temporary identifier is based on a database or key-value store to ensure uniqueness before use, and the processing circuitry is configured to encode, for transmission to the UE, a UE temporary identifier, and decode the UE temporary identifier from the UE during authentication for a session prior to reception of the EAP-Request/5G-NAS packet, the UE temporary identifier used to map the UE to a TNGF Key (K_{TNGF}) of the TNGF.

Example 19 is a non-transitory computer-readable storage medium that stores instructions for execution by one or more processors of a user equipment (UE), the one or more processors configured to, when the instructions are executed: decode, from a Trusted Non-3GPP Access Point (TNAP), an Extensible Authentication Protocol (EAP)-Request/5th generation (5G)-Start packet to initiate an EAP-5G session; in response to the EAP-Request/5G-Start packet, encode, for transmission to the TNAP, an EAP-Response/5G-non-access stratum (NAS) packet that contains a Registration Request message containing UE security capabilities and an anonymous Subscription Concealed Identifier (SUCI); and after transmission of the EAP-Response/5G-NAS packet, decode, from the TNAP, an EAP-Request/5G-NAS packet that contains: a NAS Security Mode Command (SMC) message including an EAP-Success message indicating authentication of the UE, a trusted non-3GPP gateway function (TNGF) address, and a shrouded identifier.

In Example 20, the subject matter of Example 19 includes, wherein: the shrouded identifier is at least one of the anonymous SUCI or a unique temporary identifier allocated by a TNGF, during authentication, the one or more processors are configured to, when the instructions are executed: initiate an Internet Key Exchange authentication (IKE_AUTH) exchange with the TNGF that uses the at least one of the anonymous SUCI or unique temporary identifier; encode, for transmission to the TNGF, an IKE_AUTH request that includes the at least one of the anonymous SUCI or unique temporary identifier; and decode, from the TNGF in response to the IKE_AUTH request, an IKE_AUTH response that includes the at least one of the anonymous SUCI or unique temporary identifier.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE), the apparatus comprising:
processing circuitry configured to:
decode, from a Trusted Non-3GPP Access Point (TNAP), an Extensible Authentication Protocol (EAP)-Request/5th generation (5G)-Start packet to initiate an EAP-5G session;
in response to the EAP-Request/5G-Start packet, encode, for transmission to the TNAP, an EAP-Response/5G-non-access stratum (NAS) packet that contains a Registration Request message containing UE security capabilities and an anonymous Subscription Concealed Identifier (SUCI); and
after transmission of the EAP-Response/5G-NAS packet, decode, from the TNAP, an EAP-Request/5G-NAS packet that contains: a NAS Security Mode Command (SMC) message including an EAP-Success message indicating authentication of the UE, a trusted non-3GPP gateway function (TNGF) address, and a shrouded identifier; and
a memory configured to store the anonymous SUCI.

2. The apparatus of claim 1, wherein the shrouded identifier is at least one of the anonymous SUCI or a unique temporary identifier allocated by a TNGF.

3. The apparatus of claim 2, wherein the processing circuitry is configured to initiate an Internet Key Exchange authentication (IKE_AUTH) exchange with the TNGF that uses the at least one of the anonymous SUCI or unique temporary identifier.

4. The apparatus of claim 3, wherein initiate the IKE_AUTH exchange with the TNGF, the processing circuitry is configured to:
encode, for transmission to the TNGF, an IKE_AUTH request that includes the at least one of the anonymous SUCI or unique temporary identifier; and
decode, from the TNGF in response to the IKE_AUTH request, an IKE_AUTH response that includes the at least one of the anonymous SUCI or unique temporary identifier.

5. The apparatus of claim 2, wherein the at least one of the anonymous SUCI or unique temporary identifier is a random number.

6. The apparatus of claim 2, wherein the at least one of the anonymous SUCI or unique temporary identifier is sent to the UE over a layer-2 connection and at least one of a message authentication code (MAC) or a digital signature is used to provide integrity protection for the at least one of the anonymous SUCI or unique temporary identifier.

7. The apparatus of claim 6, wherein the processing circuitry is configured to:
share a secret key with the TNGF during security setup after reception of the EAP-Request/5G-NAS packet; and
verify the at least one of the MAC or digital signature before using the at least one of the anonymous SUCI or unique temporary identifier during initiation of an Internet Key Exchange authentication (IKE_AUTH) exchange with the TNGF that uses the at least one of the anonymous SUCI or unique temporary identifier.

8. The apparatus of claim 2, wherein the unique temporary identifier is unique for each SUCI and mapped to a TNGF Key (K_{TNGF}) of the TNGF.

9. The apparatus of claim 2, wherein the processing circuitry is configured to:
generate a UE temporary identifier unique for each session; and
encode the UE temporary identifier for transmission to the TNGF during authentication for a session prior to reception of the EAP-Request/5G-NAS packet, the UE temporary identifier used to map the UE to a TNGF Key (K_{TNGF}) of the TNGF and discarded after the session.

10. The apparatus of claim 9, wherein the processing circuitry is configured to generate the UE temporary identifier randomly based on a Universally Unique Identifier (UUID) of the UE.

11. The apparatus of claim 9, wherein the processing circuitry is configured to generate the UE temporary identifier by adding a timestamp or random salt to another generated temporary identifier.

12. The apparatus of claim 9, wherein the processing circuitry is configured to generate the UE temporary identifier randomly based on a hash function of personal information of a user of the UE.

13. The apparatus of claim 2, wherein:
the unique temporary identifier is based on a database or key-value store to ensure uniqueness before use, and
the processing circuitry is configured to decode, from the TNGF, a UE temporary identifier, and encode the UE temporary identifier for transmission to the TNGF during authentication for a session prior to reception of the EAP-Request/5G-NAS packet, the UE temporary identifier used to map the UE to a TNGF Key (K_{TNGF}) of the TNGF.

14. An apparatus for a Trusted Non-3GPP Access Point (TNAP), the apparatus comprising:
processing circuitry configured to:
encode, for transmission to a user equipment (UE), an Extensible Authentication Protocol (EAP)-Request/5^{th} generation (5G)-Start packet to initiate an EAP-5G session;
in response to the EAP-Request/5G-Start packet, decode, from the UE, an EAP-Response/5G-NAS packet that contains a Registration Request message containing UE security capabilities and an anonymous Subscription Concealed Identifier (SUCI); and
after reception of the EAP-Response/5G-NAS packet, encode, for transmission to the UE, an EAP-Request/5G-NAS packet that contains: a NAS Security Mode Command (SMC) message including an EAP-Success message indicating authentication of the UE, a trusted non-3GPP gateway function (TNGF) address, and a shrouded identifier; and
a memory configured to store the unique temporary identifier.

15. The apparatus of claim 14, wherein the shrouded identifier is at least one of the anonymous SUCI or a unique temporary identifier allocated by a TNGF.

16. The apparatus of claim 15, wherein the processing circuitry is configured to:
decode, from the UE, an Internet Key Exchange authentication (IKE_AUTH) request that includes the at least one of the anonymous SUCI or unique temporary identifier; and
encode, for transmission to the UE in response to the IKE_AUTH request, an IKE_AUTH response that includes the at least one of the anonymous SUCI or unique temporary identifier.

17. The apparatus of claim 15, wherein the at least one of the anonymous SUCI or unique temporary identifier is a random number.

18. The apparatus of claim 15, wherein:
the unique temporary identifier is based on a database or key-value store to ensure uniqueness before use, and
the processing circuitry is configured to encode, for transmission to the UE, a UE temporary identifier, and decode the UE temporary identifier from the UE during authentication for a session prior to reception of the EAP-Request/5G-NAS packet, the UE temporary identifier used to map the UE to a TNGF Key (K_{TNGF}) of the TNGF.

19. A non-transitory computer-readable storage medium that stores instructions for execution by one or more processors of a user equipment (UE), the one or more processors configured to, when the instructions are executed:
decode, from a Trusted Non-3GPP Access Point (TNAP), an Extensible Authentication Protocol (EAP)-Request/5^{th} generation (5G)-Start packet to initiate an EAP-5G session;
in response to the EAP-Request/5G-Start packet, encode, for transmission to the TNAP, an EAP-Response/5G-non-access stratum (NAS) packet that contains a Registration Request message containing UE security capabilities and an anonymous Subscription Concealed Identifier (SUCI); and
after transmission of the EAP-Response/5G-NAS packet, decode, from the TNAP, an EAP-Request/5G-NAS packet that contains: a NAS Security Mode Command (SMC) message including an EAP-Success message indicating authentication of the UE, a trusted non-3GPP gateway function (TNGF) address, and a shrouded identifier.

20. The non-transitory computer-readable storage medium of claim 19, wherein:
the shrouded identifier is at least one of the anonymous SUCI or a unique temporary identifier allocated by a TNGF, and
during authentication, the one or more processors are configured to, when the instructions are executed:
initiate an Internet Key Exchange authentication (IKE_AUTH) exchange with the TNGF that uses the at least one of the anonymous SUCI or unique temporary identifier;
encode, for transmission to the TNGF, an IKE_AUTH request that includes the at least one of the anonymous SUCI or unique temporary identifier; and
decode, from the TNGF in response to the IKE_AUTH request, an IKE_AUTH response that includes the at least one of the anonymous SUCI or unique temporary identifier.
